(19) United States
(12) Patent Application Publication
(10) Pub. No.: US 2005/0042986 A1
(43) Pub. Date: Feb. 24, 2005

(54) Method and apparatus for access checking and access control

(76) Inventor: Mikael Willgert, Spanga (SE)

Correspondence Address: ALFRED J MANGELS, 4729 CORNELL ROAD, CINCINNATI, OH, 452412433, US

(21) Appl. No.: 10/475,210

(22) PCT Filed: Apr. 16, 2002
(86) PCT No.: PCT/SE02/00747

(30) Foreign Application Priority Data
Apr. 18, 2001 (SE) 0101357-2

(51) Int. Cl. H04B 7/00

(52) U.S. Cl. 455/41.2; 455/500

(57) ABSTRACT

A method and apparatus for checking and controlling access to mobile telephones, computers or related devices with regard to transactions and to the handling of information, respectively. The user is provided with a user-specific identification tag that communicates with the mobile telephone or computer via a radio wave transmitter/receive unit that has a short range. The identification tag exchanges with the telephone or the computer identity information carried by the identification tag to ratify identification of the user, and to thereby control access to the telephone or computer.

BACKGROUND OF THE INVENTION

1. Field of the Invention

The present invention relates to a method and to an apparatus for access checking and access control.

2. Description of the Related Art

Computers and mobile telephones are now used as instruments for performing transactions and affixing different kinds of signatures. Computers are also used to an ever-increasing extent to access information that is covered by differing degrees of secrecy. In this regard, it often suffices to log-in with a password or a PIN code so as to enable transactions to be performed or information to be handled over a certain time period. This means that a terminal can remain open for unauthorized use if left unattended, or information may be stolen within a given period of time from when the user logged-in.

In order to prevent this, there is a need for codes or for the use of magnetic cards or so-called smart cards, as a means of identification. One drawback with systems of this nature is that the user often perceives the system as troublesome and consequently often attempts to utilize shortcuts, therewith lowering the security level.

This problem is solved by means of the present invention.

### BACKGROUND OF THE INVENTION

The present invention relates to a method of checking and controlling access to mobile telephones, computers or corresponding devices for transactions and handling of information, respectively, user is provided with a user-specific identification tag which communicates with the mobile telephone or with computers in an area in the vicinity of the telephone or the computer via radio waves. A transmitter/receiver unit of the identification tag has a short range with respect to radio waves. The identification tag exchanges with the telephone and the computer, respectively, information that includes identification of the identification tag, and such identification is considered to ratify the identification of the user.

The invention also relates to apparatus for carrying out the method.

### BRIEF DESCRIPTION OF THE DRAWING

The invention will now be described in more detail partly with reference to an exemplifying embodiment of the invention illustrated in the accompanying drawing, in which

FIG. 1 shows an identification tag and a computer; and

FIG. 2 shows an identification tag and a telephone.

### DESCRIPTION OF THE PREFERRED EMBODIMENTS

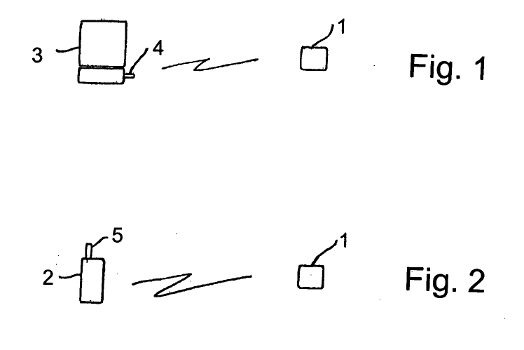

FIGS. 1 and 2 show an identification tag 1 which is intended to be carried by a user, for instance around his/her neck. The identification tag is of a kind known per se and will conveniently have the form of a transponder which receives and retransmits an incoming radio signal back to the transmitter/receiver unit from which the incoming signal was transmitted. The tag may include information relating to the identity of the owner, for instance his/her employment number, although it may also contain other information, such as the level of authority of the employee in respect of his/her use of the computer system. The tag may also include codes for enabling transactions to be carried out, such as payments, while using a computer or a telephone.

The present invention thus also relates to a method for checking and controlling access to mobile telephones 2, computers 3 or like devices for carrying out transactions and handling information , as shown schematically in FIGS. 2 and 1, respectively.

According to the invention, the identification tag 1 communicates with said mobile telephone 2 or said computer 3 via radio waves, in a space in the vicinity of the telephone or computer. A radio wave transmitter/receiver unit of the identification tag 1 has a short range. The identification tag 1 also transmits to the telephone or the computer, respectively, information that includes identification corresponding with the identification tag. Such identification is considered to ratify the identity of the user.

The transmitter/receiver unit of the computer shown in FIG. 1 include an antenna 4. The mobile telephone also includes an antenna 5.

In conjunction with the identification process, data, such as codes concerning authorized access or transactions, are sent to the telephone or to the computer. Such data can either be transmitted from the tag to the computer or the telephone, or, alternatively, there may be sent from the tag a code which causes the computer or the telephone to fetch data from a memory device.

According to one preferred embodiment of the invention, the telephone 2 or the computer 3 ascertains at least during regular short time intervals whether or not the identification tag is located within a given communications area determined by said range. This is effected by virtue of the telephone or the computer sending an inquiry signal to the tag 1, which responds to the signal.

According to another preferred embodiment, one or more of the functions of the telephone or the computer may be used solely when an identification tag has been identified by the telephone or the computer. The presence of a tag is therefore a necessary prerequisite for enabling at least certain functions to be carried out. With regard to a computer, access to certain programs can be prevented unless a tag that provides access to such programs is detected. With regard to a telephone, certain services, such as pay services, can be prevented from being carried out unless a tag which allows access to such services is detected by the telephone.

It is also preferred that one or more of the functions of the telephone or the computer will cease to act when the identification tag leaves said communications area.

It is preferred that the aforesaid range is restricted to an area of about 10 meters. A still shorter range, namely a range of about 2 meters, is required in certain other use applications. One such use application is when many personal computers are in close proximity to one another, and where a tag only activates one of those computers.

According to another preferred embodiment of the invention, radio communication takes place in accordance with the so-called Bluetooth technology. In this case, a Bluetooth module is incorporated in the computer and one is incorporated in the identification tag, respectively. It is also possible to use some other radio technique, such as WLAN (Wireless Local Area Network). However, irrespective of the radio technology used, it is essential that the range can be made sufficiently short for the tag to be recognized solely by the devices intended.

Although the invention has been described above with reference to a number of exemplifying embodiments, it will be understood that the identification tag also can be used for other purposes than those mentioned, such as for passage control.

The present invention shall not therefore be considered limited to the above-described exemplifying embodiments, since modifications can be made within the scope of the accompanying claims.

1. A method for checking and controlling access to electronic devices such as mobile telephones, computers, or corresponding devices with regard to transactions and handling of information, respectively, said method comprising the steps of: providing a user with a user-specific identification tag having user identity information and including a radio wave transponder which retransmits an incoming radio signal back to a radio wave transmitter/receiver unit associated with the electronic device that transmitted said incoming signal, wherein a radio wave transmitter/receiver unit of the identification tag has a predetermined short transmitting range; communicating via Bluetooth wireless transmission between the identification tag and the electronic device in a predetermined communications area adjacent to the electronic device; and exchanging between the identification tag and the electronic device identity information carried by the identification tag to ratify identification of the user, wherein one or more functions of the electronic device can only be performed subsequent to a given identification tag having been identified and accepted by the electronic device giving access to said functions.

2. A method according to claim 1, including the step of ascertaining at least at uniform short time intervals whether or not the identification tag is situated within the predetermined communications area determined by said range.

3. A method according to claim 2, including the step of terminating access to the electronic device when the identification tag leaves said predetermined communications area.

4. A method according to claim 1, wherein the predetermined range is less than about 10 meters.

5. Apparatus for checking and controlling access to electronic devices such as mobile telephones, computers, or corresponding devices with regard to transactions and handling of information, respectively, said apparatus comprising: a user-specific identification tag having user identity information and including a transponder which retransmits an incoming radio signal back to a radio wave transmitter/receiver unit associated with the electronic device that transmitted said incoming signal, wherein the identification tag has a predetermined short transmitting range in that the identification tag communicates according to Bluetooth wireless transmission with said electronic device via radio waves in an area adjacent to the electronic device, wherein the identification tag exchanges with the electronic device information carried by the identification tag; and wherein the user is considered to have been identified by such information exchange and wherein one or more functions of the electronic device can only be carried out subsequent to a given identification tag having been identified and accepted by the electronic device giving access to said functions.

6. Apparatus according to claim 5, wherein the electronic device ascertains at least at uniform short time intervals whether or not the identification tag is situated within a the predetermined communications area determined by said range.

7. Apparatus according to claim 5, wherein access to the electronic device is terminated when the identification tag leaves said predetermined communications area.

8. Apparatus according to claim 7, wherein the predetermined range is less than about 10 metres.
